(19) United States
(12) Patent Application Publication
(10) Pub. No.: US 2009/0168735 A1
(43) Pub. Date: Jul. 2, 2009

(54) STATION, SETTING INFORMATION MANAGING DEVICE, WIRELESS COMMUNICATION SYSTEM, SETTING INFORMATION OBTAINING METHOD, COMPUTER-READABLE MEDIUM

(76) Inventor: Yasuhiro Mizukoshi, Tokyo (JP)

Correspondence Address: NEC CORPORATION OF AMERICA, 6535 N. STATE HWY 161, IRVING, TX, 75039, US

(21) Appl. No.: 12/307,866

(22) PCT Filed: Jun. 22, 2007
(86) PCT No.: PCT/JP2007/063060

§ 371 Date: Jan. 7, 2009

(30) Foreign Application Priority Data
Jul. 7, 2006 (JP) 2006-188573

(51) Int. Cl. H04W 4/00

(52) U.S. Cl. 370/338

(57) ABSTRACT

In a wireless communication system including a setting information managing device for managing setting information required for wireless communication, an access point, and a base station belonging to the access point for conducting wireless communication, the station belongs to the access point using connecting information for wireless connection to a setting network, connects via the access point to the managing device on the setting network, and obtains the setting information from the managing device. In this way, in the wireless communication system, the setting information required for wireless communication can be obtained by use of the connecting information for wireless connection to connect to the setting network.

### BACKGROUND OF THE INVENTION

1. Field of the Invention

The present invention pertains to a wireless communication system including at least a wireless terminal or a station and a setting information managing device to manage setting information required for the station to conduct wireless communication, and in particular, to a station, a setting information managing device, a wireless communicating system, a setting information obtaining method, and a computer-readable medium storing a setting information obtaining program that enable the station to obtain wirelessly the setting information managed by the setting information managing device.

2. Description of the Related Art

A wireless communication system generally includes stations STA, wireless base stations or access points AP, a wireless Local Area Network (LAN) server device 200, an authentication information database 201, an audio communication managing server device 300, and a phone number information database 301 as shown in FIG. 18.

In the communication system of FIG. 18, when a station STA starts wireless communication, the station STA connects via the access point AP to the authentication server 200 and then sends to the server 200 setting information beforehand registered to the station STA to thereby request connection for communication.

When the connection request is received, the authentication server 200 compares the setting information from the station STA with authentication information beforehand registered to the authentication information database 201 to determine whether the setting information has been registered to the database 201 to thereby conduct authentication for the station STA. If it is determined that the setting information has been registered to the database 201, the authentication server 200 sends authentication approval notification to the station STA. When the approval is notified from the authentication server 200, the station STA establishes connection for wireless communication and initiates wireless communication.

To initiate audio communication, the station STA connects via the access point AP to the audio communication managing server 300 to feed setting information beforehand set to the station STA to the audio managing server 300 to resultantly request connection for audio communication.

On receiving the connection request for audio communication, the server 300 compares the setting information from the station STA with phone number information registered to the phone number information database 301 in advance to determine whether the setting information has been registered to the database 301 for the connection of the station STA. If it is determined that the setting information has been registered to the database 301, the server 300 transmits connection grant notification to the station STA. When the notification is received, the station STA establishes connection for audio communication to start audio communication.

In the wireless communication system shown in FIG. 18, when a large number of stations STA are installed to conduct wireless communication, it is required that the manager create the setting information needed for each station to conduct wireless communication and then sets the information to the station STA. This requires considerable human power to manually conduct the job and hence the installation cost disadvantageously soars.

To possibly reduce the installation cost in such wireless communication system including a large number of stations, developments of a system capable of automatically registering setting information required for wireless communication to the stations STA are desired.

In this connection, for example, Japanese Patent Application Laid-Open Ser. No. 2004-147101 (document 1) filed before the present invention describes a gatekeeper device having high usability and capable of automatically assigning a phone number to an Internet Protocol (IP) telephone through a simple data setting operation.

Also, according to, for example, Japanese Patent Application Laid-Open Ser. No. 2005-236537 (document 2), there is described a Voice over Internet Protocol (VoIP) using a wireless LAN which expands functions of the IP wireless LAN station while guaranteeing secrecy of the telephone call.

In addition, according to, for example, Japanese Patent Application Laid-Open Ser. No. 2004-328104 (document 3), a node device is provided which facilitates, when connected to a new user terminal, registration of information of the position of a terminal.

In addition, for example, Japanese Patent Application Laid-Open Ser. No. 2005-51625 (document 4) describes a computer system which considerably reduces the amount of jobs required for the network manager, for example, to securely set data of the wireless LAN.

However, the documents 1 to 4 does not pay attention to an event that in the operation to obtain the setting information, there is used connection information for wireless connection to establish connection to a setting network.

### SUMMARY OF THE INVENTION

An exemplary object of the invention is to provide a station, a setting information managing device, a wireless communicating system, a setting information obtaining method, and a setting information obtaining program in which by use of connection information for wireless connection to establish connection to a setting network, it is possible to acquire setting information required for wireless communication.

A station according to an exemplary aspect of the invention includes a setting information obtaining unit that connects via an access point to the setting information managing device by use of setting information for wireless connection to connect to a setting network and obtains the setting information from the setting information managing device.

A setting information managing device according to an exemplary aspect of the invention includes a setting information transmission unit that transmits the setting information to the station connected via an access point existing on a setting network to the setting information managing device.

A wireless communication system according to an exemplary aspect of the invention includes a setting information managing device that manages setting information required for wireless communication, an access point, and a base station belonging to the access point. The station includes a setting information obtaining unit that connects via an access point to the setting information managing device by use of setting information for wireless connection to connect to a setting network and obtains the setting information from the setting information managing device.

A setting information obtaining method according to an exemplary aspect of the invention includes a setting information obtaining step of connecting, by a station, via an access point to a setting information managing device by use of setting information for wireless connection to connect to a setting network, and obtaining the setting information from the setting information managing device.

A setting information obtaining method according to an exemplary aspect of the invention includes a setting information transmission step for transmitting, by a setting information managing device, setting information to a station connected via an access point existing on a setting network to the setting information managing device.

A setting information obtaining method for a wireless communication system according to an exemplary aspect of the invention includes the setting information obtaining step of connecting, by a station, via an access point to a setting information managing device by use of setting information for wireless connection to connect to a setting network, and obtaining the setting information from the setting information managing device.

A computer-readable medium having computer-executable instructions for performing a method for a station to obtain setting information, the method comprising the step of: connecting via an access point to a setting information managing device by use of setting information for wireless connection to connect to a setting network, and obtaining the setting information from the setting information managing device.

A computer-readable medium having computer-executable instructions for performing a method for a device that provides a station with setting information, the method comprising the step of: transmitting the setting information to the station connected via an access point existing on a setting network to the setting information managing device.

### BRIEF DESCRIPTION OF THE DRAWINGS

Features of the disclosed embodiments will be described by way of the following detailed description with reference to the accompanying drawings in which:

FIG. 1 is a schematic block diagram showing a system configuration of a wireless communication system;

FIG. 2 is a block diagram showing an internal configuration of a station STA;

FIG. 3 is a diagram showing an example of a table layout of a setting information management table 17 in the station STA;

FIG. 4 is a block diagram showing an internal configuration of a station STA;

FIG. 5 is a diagram showing an example of a table layout to manage setting information by a setting information managing section 102 of a setting information manager device 100 of a wireless communication system;

FIG. 6 is a sequence chart showing control operation of a wireless communication system;

FIG. 7 is a diagram showing an example of a table layout to manage setting information by a setting information managing section 102 of a setting information manager device 100 of a wireless communication system;

FIG. 8 is a sequence chart showing control operation of a wireless communication system;

FIG. 9 is a schematic block diagram showing a system configuration of a wireless communication system;

FIG. 10 is a sequence chart showing first control operation of a wireless communication system;

FIG. 11 is a sequence chart showing second control operation of a wireless communication system;

FIG. 12 is a diagram showing a display example on a display presenting the registration state of setting information managed by a setting information management table 17.

FIG. 13 is a diagram showing a table layout example of the setting information management table 17 in the station STA;

FIG. 14 is a schematic block diagram showing a system configuration of a wireless communication system;

FIG. 15 is a sequence chart showing control operation of a wireless communication system;

FIG. 16 is a first sequence chart showing control operation of a wireless communication system;

FIG. 17 is a second sequence chart showing control operation of a wireless communication system; and

FIG. 18 is a diagram showing a system configuration of a conventional wireless communication system.

### DESCRIPTION OF EXEMPLARY EMBODIMENTS

First, features will be given of a wireless communication system of exemplary embodiments.

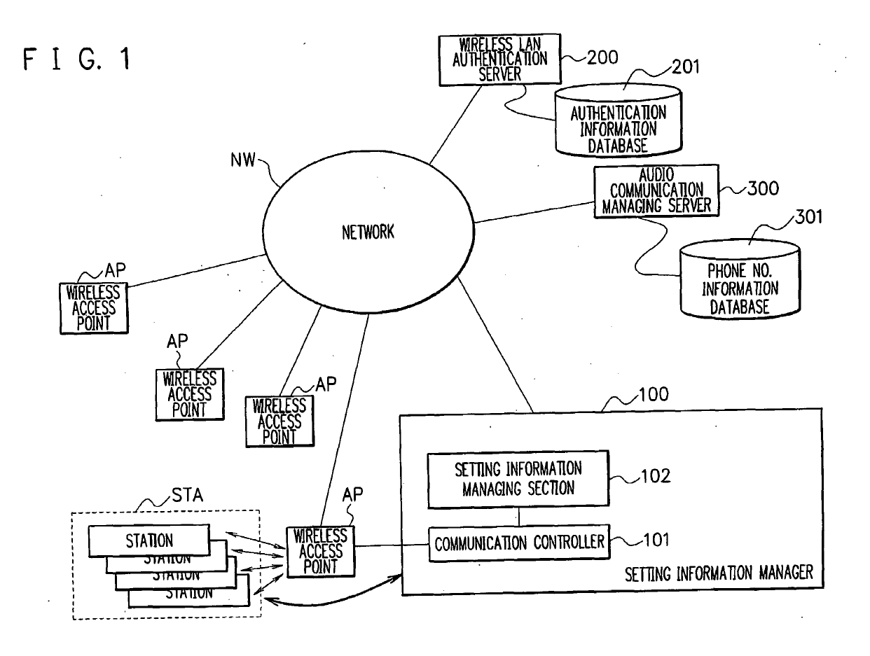

A wireless system includes a setting information manager 100 to manage setting information required for wireless communication, wireless access points AP, and stations STA that belong to access points AP to conduct wireless communication as shown in FIG. 1. The station STA belongs to an access point by use of connection information for wireless connection to connect to a setting network, connects via the access point AP to the setting information manager 100 on the setting network, and attains setting information from the manager 100. As a result, even when a large number of stations exist in the system, it is possible to easily register the setting information to each station STA. Referring next to the accompanying drawings, description will be given in detail of the wireless communication system.

### First Embodiment

Referring now to FIG. 1, description will be given of a system configuration of the wireless communication system.

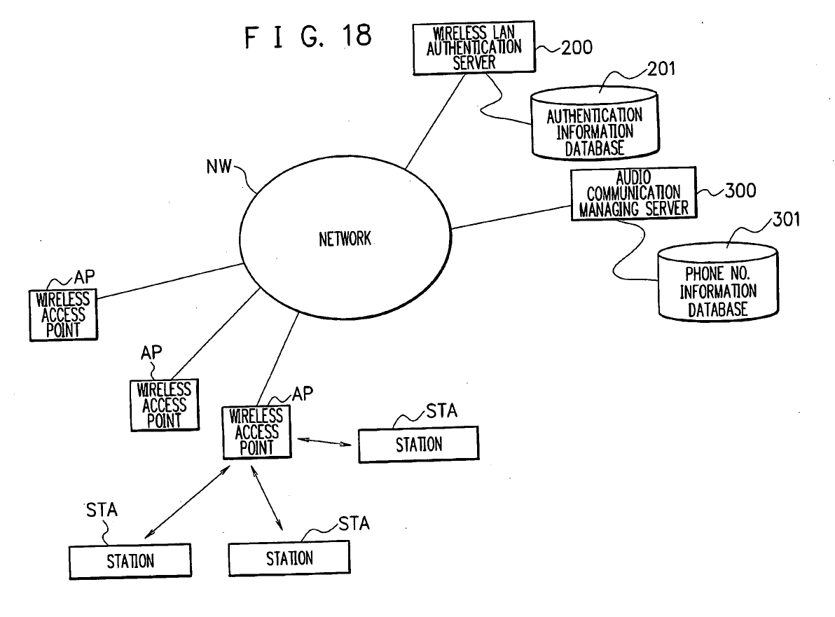

The system includes stations STA, access points AP, a setting information managing device 100, a wireless LAN server 200, an authentication information database 201, an audio communication managing server 300, and a phone number information database 301. In the configuration, the server 200, the database 201, the server 300, and database 301 respectively include functions similar to those in FIG. 18 described above.

### <Internal Configuration of Station>

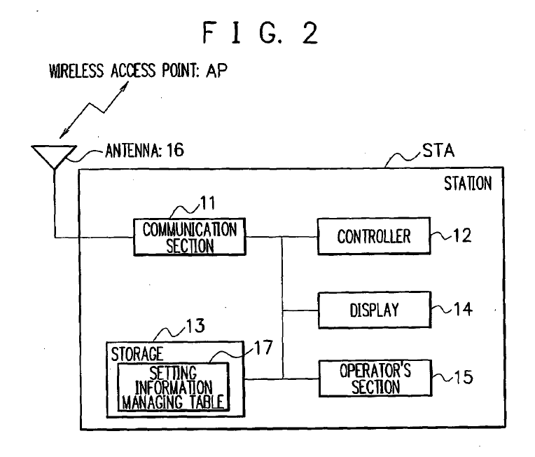

Referring next to FIG. 2, description will be given of an internal configuration of a station STA of the wireless communication system.

The station STA includes, as shown in FIG. 2, a communication module 11, a controller 12, a storage module 13, a display 14, an operator's module 15, and an antenna 16.

The communication module 11 establishes a communication via the antenna 16 to an access point AP to communicate information using a particular frequency.

The control module 12 supervises operation in the station STA.

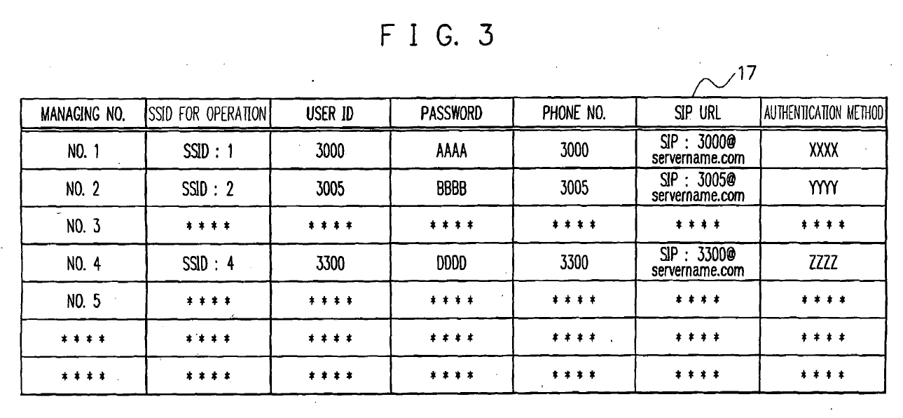

The storage module 13 stores various setting values of the station STA and temporarily keeps information communicated via the communication module 11. Also, the storage module 13 stores a Service Set Identifier (SSID) dedicatedly used to set the setting information, the identifier being required to connect to the manager 100 on the setting network. The storage module 13 also includes a setting information managing table 17 to manage setting information required for wireless communication. FIG. 3 shows a table layout of the table 17.

As can be seen from FIG. 3, the table 17 is used to register setting information necessary for the station STA to carry out wireless communication. That is, the station STA is capable of conducting wireless communication by use of the setting information registered to the table 17. In the table 17, the setting information is classified into groups for each “management number” as shown in FIG. 3.

The setting information of the table 17 includes “SSID for operation”, “user ID”, “password”, “phone number”, “SIP URL”, and “authentication method” as shown in FIG. 3. The authentication method indicates, for example, a standard prescribed by IEEE802.1x. In this regard, FIG. 3 shows only an example of setting information items registered to the table 17. Contents of the table 17 is not restricted to those in FIG. 3. Any information items obtainable by the manager 100 may be registered to the table 17.

At initialization of the station STA, the table 17 includes no setting information. Namely, the table 17 is empty. To start wireless communication, the station STA connects to the manager 100 on the setting network by use of the SSID dedicated to the setting operation to connect to the setting network. The station STA then acquires setting information controlled by the manager 100 to register the information to the table 17. Resultantly, it is possible for the station STA to carry out wireless communication using the setting information registered to the table 17. The information used to connect to the setting network is not limited to the SSID dedicated to the setting, but any information enabling connection to the setting network may be used as connection information. However, since a station having no setting information tries to connect to the manager 100 before the station join a system, it is favorable to design a system such that the station STA can connect to the setting network by use of information included beforehand in the station STA.

The display 14 presents various information items stored in the storage module 13. The display 14 presents, for example, information items registered to the table 17 shown in FIG. 3.

The operator's module 15, for example, sets various setting information items to be stored in the storage module 13 and inputs command information to execute various control operations in the station STA. The operator's module 15 sets, for example, information items registered to the table 17 of FIG. 3.

### <Internal Configuration of Access Point AP>

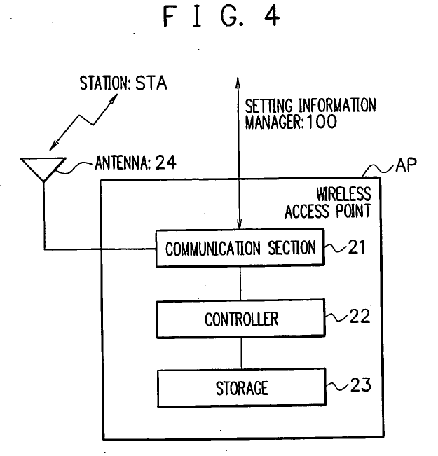

Referring next to FIG. 4, description will be given of an internal configuration of an access point AP of the wireless communication system.

As can be seen from FIG. 4, the access point AP includes a communication module 21, a controller 22, a storage module 23, and an antenna 24.

The communication module 21 establishes a wireless communication path via the antenna 24 to a station STA to communicate information using a particular frequency. The communication module 21 is also able to communicate information with other access points AP.

The controller 22 controls operation in the access point AP. The storage module 23 stores various setting values of the access point AP and temporarily holds information to be communicated via the communication module 21. The setting values stored in the storage module 23 include, for example, a radio channel and a service identifier, i.e., an SSID. In this exemplary embodiments, two kinds of SSID are used: an SSID for operation to be employed for wireless communication; and an SSID dedicated to the setting operation to be used to set setting information to the station under consideration. For an access point AP existing on a setting network (sub-net) of the manager 100, the storage module 23 stores the SSID dedicated to the setting. Therefore, when the station STA connects to the access point AP using the SSID, the access point AP transfers information to the manager 100 on the pertinent setting network to automatically establish a link between the station STA and the manager 100. By disposing a wireless access point AP dedicated to the setting, a station within a communicable range of the access point AP belongs thereto using the SSID dedicated to the setting and connects to the manager 300 on the setting network to thereby obtain setting information from the manager 300. Therefore, even if the system includes a large number of stations STA, the setting information can be easily and efficiently registered to each of the stations STA.

### <Internal Configuration of Setting Information Managing Device 100>

Referring to FIG. 1, description will be given of an internal configuration of the manager 100 of the wireless communication system.

The manager 100 includes a communication controller 101 and a setting information managing module 102.

The communication controller 101 conducts wireless communication with an access point on a setting network (sub-net). The manager 100 includes the setting-dedicated SSID beforehand registered and is capable of conducting wireless communication only with access points AP to which the setting-dedicated SSID is set in advance.

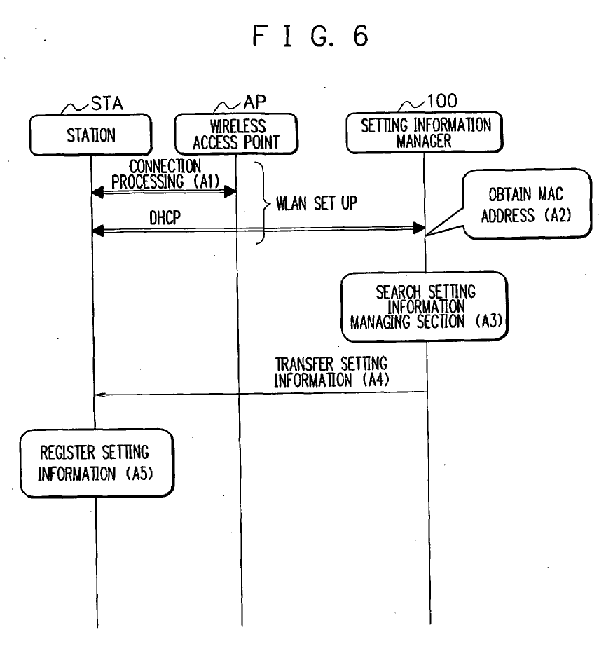

The module 102 manages setting information for a station STA to carry out wireless communication. FIG. 6 shows a layout example of the setting information managed by the module 102.

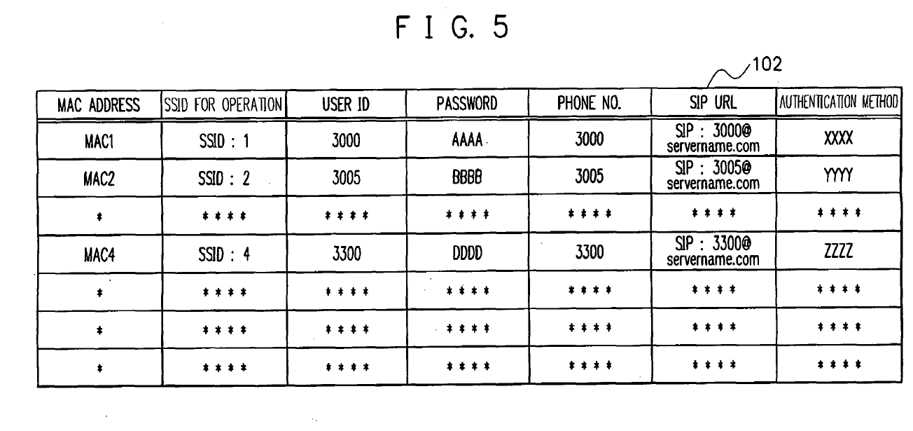

As can be seen from FIG. 5, the module 102 manages the setting information in association with a Media Access Control (MAC) address unique to each station STA. The setting information items are as those of the table 17 of a station STA, that is, “SSID for operation”, “user ID”, “password”, “phone number”, “SIP URL”, and “authentication method”. Information items registered to the database 201 and the 301 are substantially equal to information items contained in the setting information items managed by the module 102.

Referring next to FIG. 6, description will be given of a sequence of control operation steps of the wireless communication system.

First, a station STA attempts to conduct a setup operation using its setting-dedicated SSID. The station STA executes processing to connect to an access point AP to which a setting-dedicated SSID is set in advance (step A1).

When the connection processing is terminated for the connection to the access point AP by use of the SSID, the station STA broadcasts a Dynamic Host Configuration Protocol (DHCP) request to the access point AP (DHCP discover). On receiving the DHCP request, the access point AP transmits the DHCP request to the sub-net to which the access point AP belongs. As a result, the manager 100 on the sub-net receives the DHCP request from the station STA.

On received the request, the manager 100 obtains an MAC address of the station STA (step A2). Using the MAC address, the manager 100 searches the module 102 to determine whether setting information associated with the MAC address exists in the module 102 (step A3).

If it is determined that the setting information for the MAC address from the station STA exists in the module 102, the manager 100 attains the setting information from the module 102 to send the information to the station STA (DHCP offer; step A4).

The station STA receives the setting information, specifically, the setting information unique to the station STA from the manager 100. The station STA then registers the information to the table 17 (step A5). In this way, the station STA carries out wireless communication using the unique setting information received from the manager 100.

As above, the station ST belongs to the access point AP by use of the setting-dedicated SSID to connect to the setting network and then connects via the access point AP to the manager 100 on the setting network. The manager 100 obtains the MAC address unique to the station from the station STA to search the module 102 on the basis of the MAC address. The manager 100 then sends to the station STA the setting information associated with the MAC address. The station STA attains the unique setting information from the manager 100. In this way, the station STA conducts wireless communication according to the unique setting information attained from the manager 100.

### Second Exemplary Embodiment

Next, a second exemplary embodiment will be described.

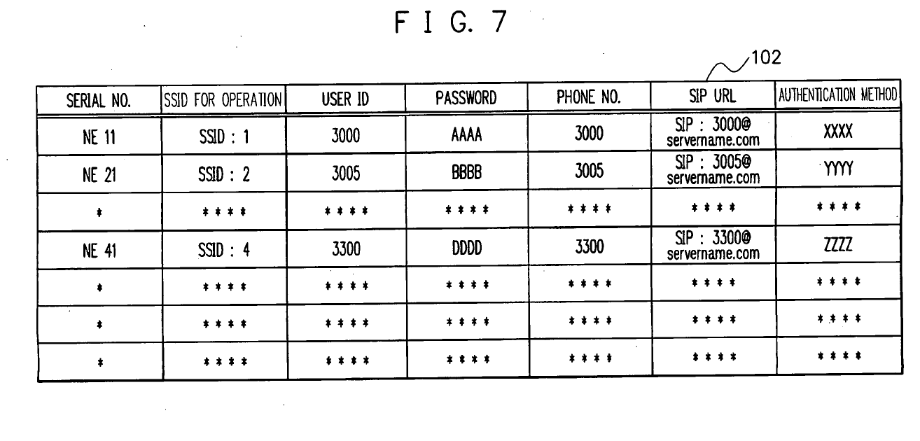

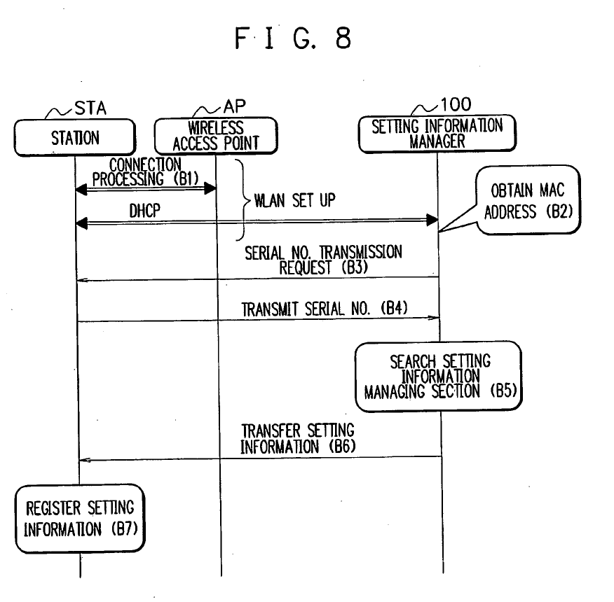

In the first exemplary embodiment, the setting information manager 100 searches the setting information managing module 102 on the basis of the MAC address obtained from the station STA and then sends to the station STA the setting information corresponding to the MAC address. As a result, the station STA acquires the setting information unique to the station. In the second exemplary embodiment, the station STA sends a unique serial number to the manager 100. Using the serial number, the manager 100 searches the module 102 and transmits setting information associated with the serial number to the station STA. The station STA resultantly obtains the unique setting information as in the first exemplary embodiment. A wireless communication system is substantially equal in the configuration to the first exemplary embodiment shown in FIG. 1. Next, referring to FIGS. 7 and 8, description will be given in detail of the wireless communication system.

First, description will be given of internal structure of a setting information manager 100 in the second exemplary embodiment.

The manager 100 includes, as in the first exemplary embodiment, a communication controller 101 and a setting information managing module 102. The module 102 manages the setting information on the basis of “serial number” unique to each station STA as shown in FIG. 7. The setting information includes, like that registered to the setting information managing table 17 of a station STA shown in FIG. 3, “user ID”, “password”, “phone number”, “SIP URL”, and “authentication method”.

Referring next to FIG. 8, description will be given of steps of a control operation.

First, a station STA tries to conduct a setup operation based on a setting-dedicated SSID. The station STA conducts connection processing to connect to an access point AP to which a setting-dedicated SSID has been set (step B1).

After the connection processing is completely finished, the station STA sends a DHCP request in the broadcast mode to the access point (DHCP discover). On receiving the DHCP request, the access point AP transmits the DHCP request to the sub-net to which the access point AP belongs. Resultantly, the manager 100 existing on the sub-net receives the DHCP request from the station STA.

When the DHCP request is received, the manager 100 obtains an MAC address of the station STA (step B2). On the basis of the MAC address, the manager 100 sends to the station STA a transmission request for a serial number unique to the station STA (DHCP offer; step B3).

On receiving the serial number transmission request from the manager 100, the station STA delivers the unique serial number to the manager 100 (DHCP request; step B4).

When the serial number is received, the manager 100 searches the module 102 to determine whether setting information corresponding to the serial number is present in the module 102 (step B5).

If it is determined that the setting information is present therein, the manager 100 attains the information from the module 102 and feeds the setting information to the station STA (DHCP Ack; step B6).

The station STA receives the setting information, namely, unique setting information from the manager 100. The station STA registers the setting information to the table 17 (step B7). Then the station STA can carry out wireless communication by use of the setting information obtained from the manager 100.

In this way, using the setting-dedicated SSID to connect to the setting network, the station STA belongs to the access point AP to connect via the access point AP to the manager 100 on the setting network. On the basis of the MAC address, the manager 100 sends to the station ST a transmission request for a serial number unique to the station STA. Thereafter, using the serial number attained from the station STA, the manager 100 searches the module 102 such that the manager 100 sends to the station STA the setting information associated with the serial number. The station STA attains the setting information unique thereto from the manager 100. This enables the station STA to carry out wireless communication by use of the setting information. Although the second exemplary embodiment employs the serial number unique to the station STA, the present embodiment is not restricted to the serial number. Any identification information unique to the station STA is applicable.

### Third Exemplary Embodiment

Description will now be given of the third exemplary embodiment.

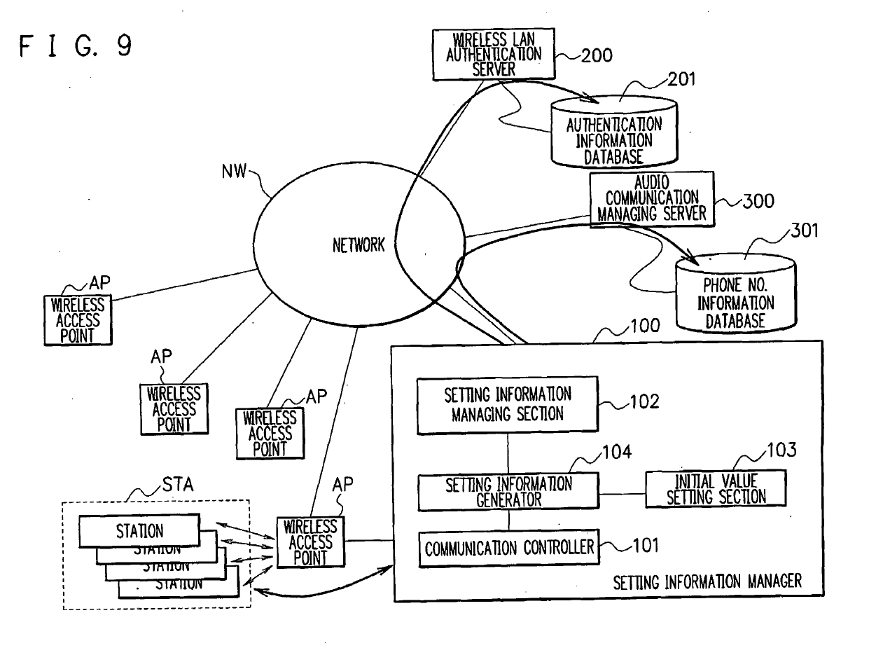

In the first and second exemplary embodiments, the setting information manager 100 is supposed to manage the setting information unique to the station STA. Under this condition, the station STA obtains the setting information from the manager 100. In accordance with an aspect of the third exemplary embodiment, the manager 100 obtains from the station STA identification information that is unique to the station and generates setting information unique to the station STA on the basis of the identification information. The manager 100 also delivers the setting information to the station STA. As a result, the station STA acquires the unique setting information. Consequently, the manager can 100 automatically create, by use of the identification information, setting information unique to the station STA to thereby manage the setting information and to register the setting information to the station STA. Referring now to FIGS. 9 to 11, description will be given of the third exemplary embodiment of the wireless communication system.

Referring now to FIG. 9, description will be given of a system configuration of the wireless communication system.

The system includes, as shown in FIG. 9, stations STA, wireless access points AP, a setting information manager 100, a wireless LAN authentication server 200, an authentication information database 201, an audio communication managing server 300, and a phone number information database 301. The third exemplary embodiment is functionally similar to the first and second exemplary embodiments except the manager 100.

Next, referring to FIG. 9, description will be given of an internal configuration of the manager 100.

The manager 100 includes a communication control module 101, a setting information managing module 102, an initial value setting module 103, and a setting information generator 104 as shown in FIG. 9.

The module 103 possesses in advance initial values used to create setting information unique to the respective station STA. The initial values are beforehand registered to the setting module 103. In this exemplary embodiment, “phone numbers” are set as the initial values. For example, “phone numbers” 3000 to 3999 amounting to 1000 stations are beforehand registered.

The generator 104 creates setting information unique to each station STA. The generator 104 creates the setting information for a station STA using identification information unique to the station STA received from the station STA (e.g., an MAC address or a serial number) and an initial value (phone number) in the module 103.

Subsequently, description will be given of an example of operation in which the generator 104 creates setting information unique to a station STA.

For a first station STA, the generator 104 reads out a phone number “3000” from the module 103. Using the telephone number “3000” and the identification information, the generator 104 creates setting information unique to the station STA. The setting information unique to the station STA may be, for example, “SSID for operation”=SSID*; “user ID”=3000, “password”=XXXXXXXX (random), “phone number”=3000, “SIP URL”=SIP:3000@servername.com, and “authentication method”. The generator 104 controls operation to prevent duplicated use of a phone number obtained from the module 103.

The generator 104 does not use the same phone number to create setting information items unique to a station STA on the basis of “identification information”=X (an MAC address, a serial number, or the like) unique to the station STA and a “phone number” registered to the module 103. Therefore, the generator 104 does not create duplicate setting information item.

The setting information thus created by the generator 104 is registered to the module 102 with a relationship established to the identification information (such as an MAC address or a serial number). The module 102 manages the setting information unique to the station STA in a table layout shown in FIGS. 5 and 7.

The manager 100 sends the setting information created by the generator 104 to the server 200 and the server 300, and registers the setting information to the database 201 and the database 301.

For example, the manager 100 selects authentication information required for the connection request for wireless communication from the setting information created by the generator 104 and delivers the authentication information to the server 200. The server 200 receives the authentication information and registers the information to the database 201. “SSID for operation”, “user ID”, “password”, and “authentication method” are registered as authentication information items to the database 201.

The manager 100 selects phone number information required for the connection request for audio communication from the setting information and feeds the selected information to the server 300. The server 300 receives and registers the information to the database 301. “Phone number” and “SIP URL” are registered as phone number information items to the database 301.

The manager 100 registers the setting information created by the generator 104 to the station STA.

As a result, the station STA acquires the setting information required to conduct wireless communication with the server 200 and the server 300. Using the setting information attained as above, the station STA conducts the connection processing for wireless communication with the server 200 and for audio communication with the server 300.

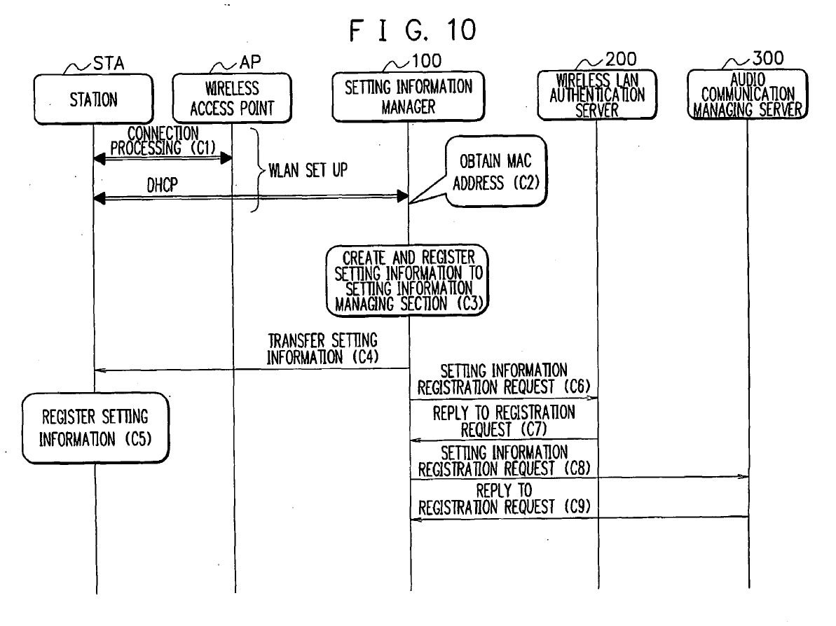

Referring now to FIG. 10, description will be given of a first control operation.

First, the station STA attempts to conduct the setup operation by using a setting-dedicated SSID. The station STA executes processing to connect to an access point AP to which a setting-dedicated SSID is set (step C1).

When the connection processing is terminated, the station STA transmits a DHCP request in a broadcast mode to an access point (DHCP discover). On receiving the DHCP request, the AP sends the DHCP request to the sub-net to which the access point belongs. The device 100 on the sub-net then receives DHCP request from the station STA.

When the DHCP request is received, the manager 100 obtains an MAC address of the station STA (step C2). According to the MAC address attained from the station STA and a phone number beforehand registered to the module 103, the manager 100 creates setting information unique to the station STA. The manager 100 registers the setting information to the module 102 (step C3).

Thereafter, the manager 100 sends the setting information to the station STA (step C4).

The station STA receives and obtains the setting information from the manager 100. The station STA registers the setting information to the setting information managing table 17 (step C5). Consequently, the station STA is able to conduct wireless communication using the setting information.

The manager 100 sends the setting information to the server 200 to request registration of the setting information (step C6). The server 200 registers the setting information to the database 201 and then replies to the registration request (step C7). The authentication server 200 manages by use of the database 201 the authentication information necessary to execute the connection processing for wireless communication.

Also, the manager 100 delivers the setting information to the server 300 to request registration of the setting information (step C8). The server 300 registers the setting information to the database 301 and replies to the registration request (step C9). As a result, the server 300 manages by use of the database 301 the phone number information required to conduct the connection processing for audio communication.

As above, the station STA belongs to the access point using the setting-dedicated SSID to connect to the setting network and then connects via the access point AP to the manager 100 existing on the setting network. Based on the MAC address unique to the station STA that is obtained when the manager 100 is coupled with the station STA, the manager 100 creates the setting information unique to the station STA to send the information to the station STA. The station STA resultantly obtains the unique setting information. Also; the manager 100 transmits the setting information to the server 200 and the server 300 to thereby register the setting information to the database 201 and the database 301. This allows the station STA to achieve the wireless communication by use of the setting information. The manager 100 is able to automatically register to the databases 201 and 301 the setting information of a new station STA connected thereto using the setting-dedicated SSID to connect to the setting network.

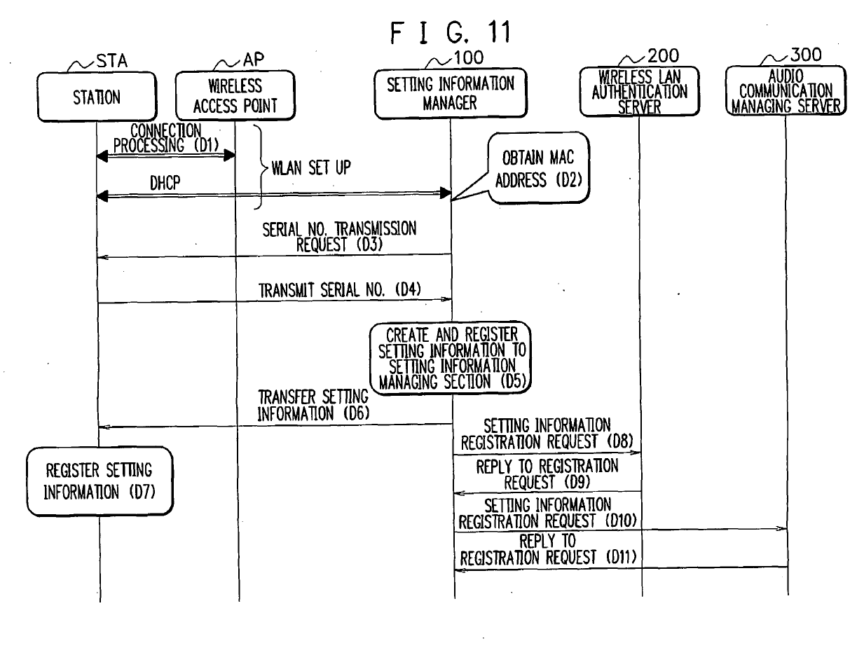

Referring next to FIG. 11, description will be given of a second control operation.

First, the station STA tries to conduct the setup operation using a setting-dedicated SSID. The station STA carries out connection processing to connect to an access point AP to which a setting-dedicated SSID is set in advance (step D1).

When the connection processing is finished, the station STA delivers a DHCP request in the broadcast mode to the access point (DHCP discover). On receiving the DHCP request, the AP transmits the DHCP request to the sub-net to which the access point AP belongs. As a result, the device 100 on the sub-net receives the DHCP request from the station STA.

When the DHCP request is received, the manager 100 obtains an MAC address of the station STA (step D2). According to the MAC address attained from the station STA, the manager 100 sends to the station STA a transmission request for a serial number unique to the station STA (step D3).

On receiving the serial number transmission request from the manager 100, the station STA feeds the serial number to the manager 100 (step D4).

When the serial number is received, the manager 100 generates setting information unique to the station STA using the serial number and a phone number set to the module 103. The manager 100 registers the setting information to the module 102 (step D5).

The manager 100 then sends the setting information unique to the station STA to the station STA (step D6).

The station STA receives the setting information, namely, unique setting information from the manager 100. The station STA then registers the setting information to the setting information managing table 17 (step D7). Therefore, the station STA carries out the wireless communication by use of the setting information obtained from the manager 100.

The manager 100 sends the setting information to the server 200 to request registration of the setting information (step D8). The server 200 registers the setting information to the database 201 to reply to the setting information registration request (step D9). The server 200 manages by use of the database 201 the authentication information required for the connection processing to conduct the wireless communication.

Also, the manager 100 sends the setting information unique to the station STA to the server 300 to request registration of the setting information (step D10). The server 300 registers the setting information to the database 301 and replies to the registration request (step D11). As a result, the server 300 manages by the database 301 the phone number information required at execution of the connection processing for audio communication.

As described above, by use of the setting-dedicated SSID for connecting to the setting network, the station STA belongs to the access point AP to connect via the access point AP to the manager 100 on the setting network. On the basis of the MAC address thus obtained from the station STA, the manager 100 sends to the station ST a transmission request for a serial number unique to the station STA. The station STA sends a serial number to the manager 100. Based on the serial number, the manager 100 creates setting information unique to the station STA to send the information to the station. The station STA resultantly acquires the unique setting information. Also, the manager 100 delivers the setting information to the authentication server 200 and the audio communication managing server 300 to thereby register the setting information to the databases 201 and 301. Consequently, the station STA conducts the wireless communication using the setting information. The manager 100 can also automatically register to the databases 201 and 301 the setting information of a new station STA using the setting-dedicated SSID for connecting to the setting network.

### (Conditions for Connection to the Setting Information Manager 100 Using Setting-Dedicated SSID)

Conditions concerning judgments in control operation in FIGS. 6, 8, 10 and 11 are explained below.

### (First Condition)

First condition for performing control operation in the first to third exemplary embodiments is that the station STA determines that the setting information has not been registered to the table 17 of the station.

Since the table 17 of the station STA is empty before the wireless communication is started, the wireless communication cannot be conducted. Therefore, if it is determined that the setting information has not been registered to the table 17, the station STA connects via the access point AP to the manager 100 using the setting-dedicated SSID to conduct a sequence of control steps shown in FIGS. 6, 8, 10, and 11.

### (Second Condition)

The second condition for the control operation in the first to third embodiments is as below. The station STA determines that the setting information has not been registered to a predetermined area in the table 17. For example, since the table 17 is used to manage the setting information for each “management number” as shown in FIG. 3, if the operator selects from the operator's module 15 an empty or unregistered managing number to which no setting information has been registered, the station STA determines that the setting information associated with the managing number selected from the operator's module 15 has not been registered to the table 17. The station STA connects via the access point AP to the manager 100 by use of the setting-dedicated SSID to carry out the control operation steps shown in FIGS. 6, 8, 10, and 11.

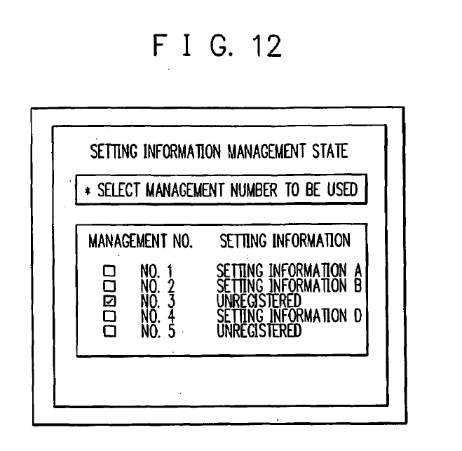

For the operator to select a managing number from the operator's module 15, the display 14 presents a display screen as shown in FIG. 12. The display screen indicates a state in which the management state of the setting information controlled by the table 17 is displayed for each managing number. The operator selects from the operator's module 15 a managing number of setting information to be employed for wireless communication. If the operator selects an empty or unregistered managing number to which setting information has not been registered as shown in FIG. 12, i.e., “managing number=no. 3”, the station STA determines that the setting information related to the selected managing number is absent from the table 17.

### (Third Condition)

The third condition to carry out the control operation of the first to third exemplary embodiments is as follows. The station STA determines that wireless communication cannot be established even if an attempt is made for wireless communication by using the setting information managed by the table 17. For example, in a situation wherein a plurality of setting information items have been registered to the table 17, the station STA sequentially reads setting information items from the table 17 to try to conduct wireless communication using the information items. After the attempt is made for all setting information items, if the station STA determines that wireless communication cannot be established, the station STA connects via the access point AP to the manager 100 using the setting-dedicated SSID and carries out the control steps shown in FIGS. 6, 8, 10, and 11. The system may be configured as below. When the operator is able to selects, from the operator's module 15, “managing number” as setting information to be employed to achieve wireless communication, if wireless communication cannot be established even by use of the setting information of “managing number”, the station STA carries out the control operation steps of FIGS. 6, 8, 10, and 11.

### (Fourth Condition)

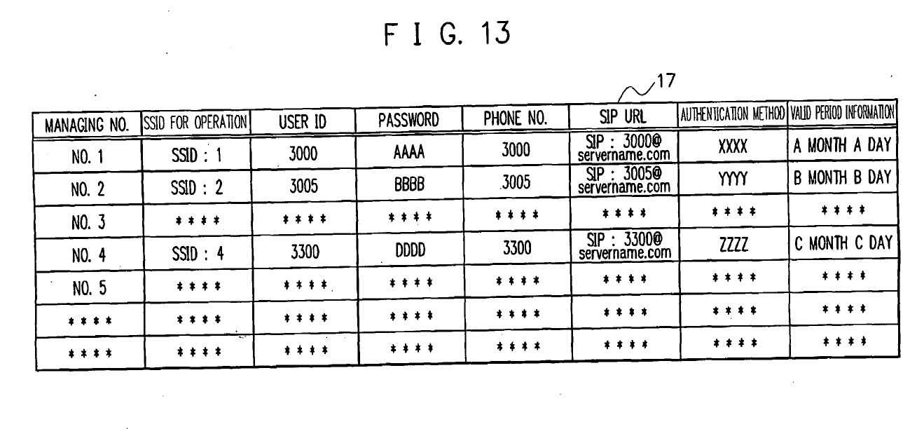

According to the fourth condition for the control operation in the first to third exemplary embodiments, the station STA determines that the valid date or period of the setting information managed by the table 17 of the station STA has expired. For example, as shown FIG. 13, when the setting information is managed in association with “valid period information”, the period of validity for the setting information, in the table 17, if the station STA determines that the validity period has expired for the setting information on the basis of “valid period information” in the table 17, the station STA connects via the access point AP to the manager 100 using the setting-dedicated SSID to carry out the control operation steps shown in FIGS. 6, 8, 10, and 11.

### (Fifth Condition)

The fourth condition to carry out the control operation in the first to third exemplary embodiments is as follows. It is determined that a request control operation is conducted to acquire setting information. For example, if the station STA determines that a request control operation has been conducted to acquire setting information, the station STA connects via the access point AP to the manager 100 using the setting-dedicated SSID to conduct the sequence of control steps shown in FIGS. 6, 8, 10, and 11.

When operation of wireless communication is to be started (at initialization), the table 17 includes no setting information registered thereto and hence the wireless communication cannot be carried out. Therefore, when the station STA is turned on, the display 14 shows a display screen to urge determination of whether a request control operation to acquire setting information is achieved. The system may also be configured such that if it is determined that a predetermined acquisition request control operation has been conducted from the operator's module 15, the control operation steps shown in FIGS. 6, 8, 10, and 11 are carried out.

The display 14 presents an inquiry screen for determining whether a request control operation for setting information is needed and then the predetermined acquisition request control operation is conducted from the operator's module 15 when: it is determined that the setting information has not been registered to the table 17 as described for the first condition; it is determine that the setting information has not been registered to a predetermined area in the table 17 as described in the second condition; it is determined that the wireless communication cannot be established even if an attempt is made to conduct wireless communication using the setting information managed by the table 17 as described for the third condition; or when it is determined that the valid period of the setting information is expired as described in the fourth condition. A condition for determining that the control operation has been conducted for a request to acquire setting information is not limited to the determination that the predetermined acquisition request control has been carried out from the operator's module 15. It is also possible to employ various conditions as triggers to determine that the request control operation has been conducted to acquire setting information.

### Fourth Exemplary Embodiment

Description will next be given of a fourth exemplary embodiment.

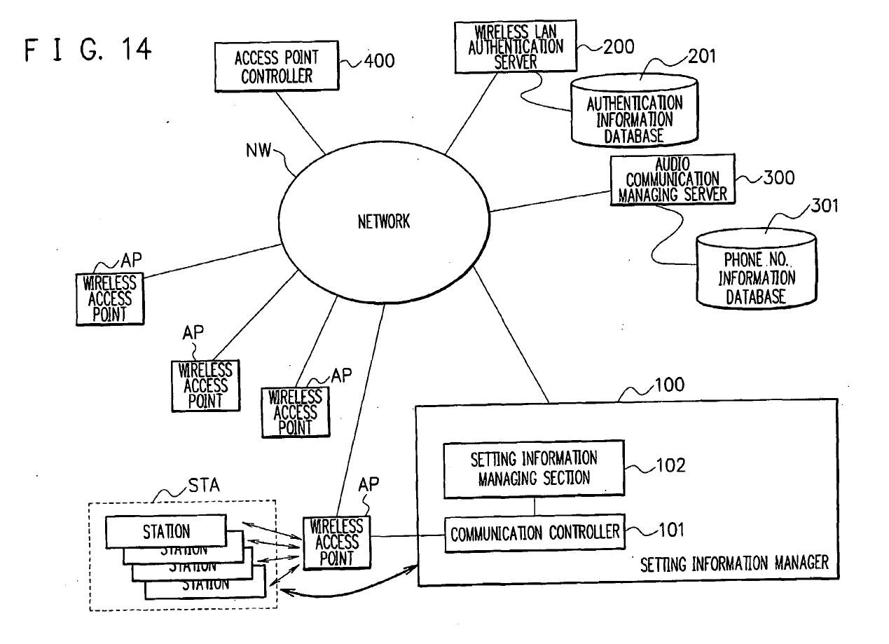

The wireless communication systems in the first and second exemplary embodiments supposed that the setting information manager 100 manages the setting information unique to the wireless station (STA) and the station STA attains the setting information from the manager 100. In an aspect of the fourth exemplary embodiment, when the setting information which is unique to the station STA and which is supervised by the manager device 100 is updated, the station STA attains the updated setting information. Therefore, even if the manager 10 updates the setting information unique to the station STA, the station STA can automatically obtain the updated information. Referring now to FIG. 14, description will be given of the wireless communication system of the fourth exemplary embodiment.

As can be seen from FIG. 14, the system includes wireless stations STA, wireless base stations or access points AP, wireless access point controller 400, a setting information manager device 100, a wireless LAN server device 200, an authentication information database 201, an audio communication managing server device 200, and a phone number information database 301.

The communication system additionally includes the wireless AC controller 400 to control the access points AP. The other configuration includes functions similar to those of the first exemplary embodiment.

The setting information updated by the manager 100 is fed to a station STA. Based on the information from the manager 100, the station STA updates the setting information controlled by use of the setting information management table 17. To confirm authenticity of the manager 100 as the source of the setting information, the station STA carries out authentication with the manager 100. After having confirmed authenticity of the manager 100, the station STA updates the setting information.

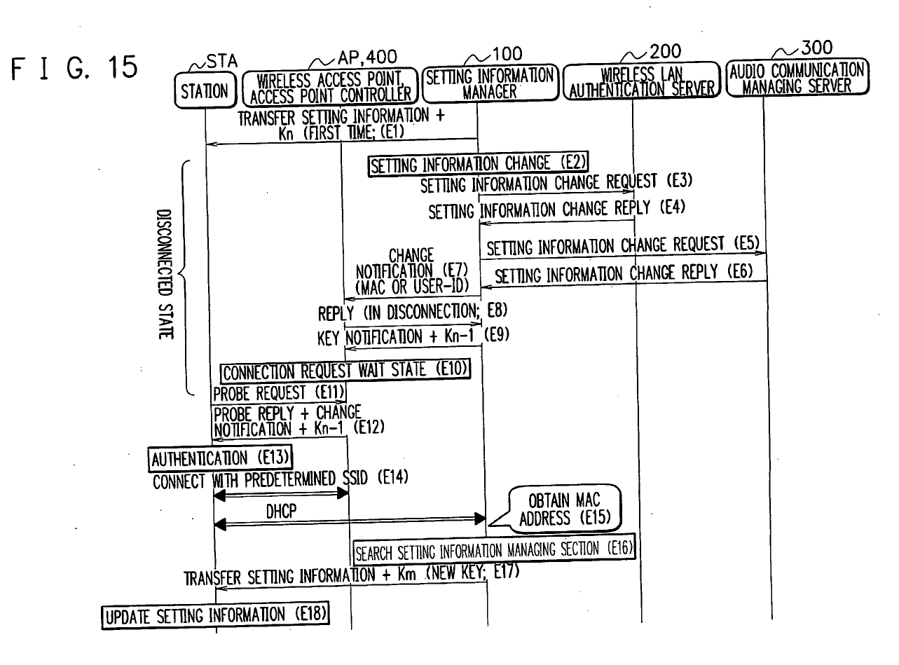

Referring next to FIG. 15, description will be given of a sequence of control operation of the wireless communication system.

The manager 100 transmits setting information supervised by the managing section 102 and key information including Kₙ and n to the station STA. The station STA receives and attains the setting information and the key information (step E1). In the processing of step E1, the control operation described for the first and second exemplary embodiments is carried out. As a result, the station STA attains the setting information and the key information, i.e., Kₙ and n from the manager 100.

In this connection, the key information including Kₙ and n is a one-time password which can be used only once. The value of Kₙ is calculated as an n-time hash value that is obtained by conducting an operation using a hash function n times for the password (pwd) as follows:

Kₙ=hash(pwd,n) (1)

wherein, pwd is a password, n is the number of iterations, and hash(*,*) is a known one-directional hash function.

The station STA manages the key information as an encryption information. After this point, the station STA disconnects the wireless communication to enter “disconnected state”.

When, for example, the manager of the manager 100 updates the setting information controlled by the managing section 102 (step E2), the manager 100 sends the updated setting information to the server 200 and thereby requests the server 200 to update the setting information (step E3). When the request is received, the server 200 registers the setting information from the manager 100 to the database 201 and then sends a response to the request (step E4). The server 200 updates authentication information controlled by using the database 201.

The manager 100 delivers the updated setting information to the server 300 to request the server 300 to update the setting information (E5). The server 300 registers the information to the database 301 and then sends a response to the update request (step E6). The server 300 thereby updates the phone number information in the database 301.

The manager 100 sends to the controller 400 a change notification related to identifying information (MAC address or user ID) to identify the station STA (step E7).

When the notification is received, the controller 400 makes a check, on the basis of the identifying information, to determine whether it is possible to connect via an access point AP to the station STA. If it is determined that the controller 400 cannot connect thereto, the controller 400 transmits a response that the station STA is in a disconnected state (in disconnection) to the manager 100 (step E8). If it is determined that the controller 400 can connect to the station STA, the controller 400 sends a response that the station STA is in a connected state to the manager 100. In this exemplary embodiment, a situation in which the station STA is in the disconnected state is explained.

When a response of the disconnected state (in disconnection) is received from the controller 400, the manager 100 delivers a change notification together with the key information including Kₙ₋₁ and n−1 to the controller 400 (step E9).

The manager 100 calculates Kₙ₋₁ as follows:

Kₙ₋₁=hash(pwd,n−1) (2)

wherein pwd is a password, n is the number of iterations, and hash(*,*) is a known one-directional hash function.

The manager 100 delivers to the controller 400 a change notification together with Kₙ₋₁ that is one less than Kₙ, Kₙ being the number of iterations previously calculated according to expression (1).

The controller 400 manages the identifying information of the station STA and the key information (Kₙ₋₁, n−1) that are received from the manager 100, the identifying information and the key information being associated. The manager 100 enters a connection request wait state to await a connection request from a station STA (step E10).

When the station STA in the connection request wait state delivers a probe request to an access point (step E11), the controller 400 assumes that a connection request is received from the station STA in the connection request wait state and hence transmits to the station STA a probe response together with the change notification and the key information (Kₙ₋₁, n−1) received from the manager 100 (step E12).

When the change notification is received from the controller 400, the station STA executes processing once on the basis of the hash function by using Kₙ₋₁ received from the controller 400 to thereby obtain Kₙ′.

Specifically, the station STA calculates Kₙ′ as follows:

Kₙ′=hash(Kₙ₋₁,1) (3)

wherein, hash(*,*) is a known one-directional hash function.

Next, the station STA compares Kₙ′ with Kₙ obtained when the previous setting information is set to thereby determine if Kₙ′ is substantially equal to Kₙ (step E13).

If it is determined that Kₙ′ is equal to Kₙ, the station STA determines that authenticity of the change notification received from the controller 400 is confirmed and hence carries out a control operation for the request to obtain setting information. The station STA conducts “setup” using a setting-dedicated SSID to carry out an operation to connect to the access point (step E14).

After the connecting operation to the access point AP is finished using the setting-dedicated SSID, the station STA sends a DHCP request in a broadcast mode to access points (DHCP discover). When the DHCP request is received, from the station STA, an access point sends the DHCP request onto the sub-net to which the access point AP belongs. As a result, the manager 100 on the sub-net receives the DHCP request from the station STA.

Having received the DHCP request, the manager 100 obtains an MAC address of the station STA (step E15). Based on the MAC address, the manager 100 searches the section 102 to attain setting information corresponding to the MAC address (step E16) and feeds the setting information and new key information including Kₘ and m to the station STA (DHCP offer; step E17).

The station STA registers the setting information to the table 17 and manages the new key information, i.e., Kₘ and m as encryption information (step E18).

Resultantly, the table 17 of the station STA is updated. If the authentication is to be subsequently carried out, the station STA conducts, by use of Kₘ and m, processing once on the basis of the hash function using Kₘ₋₁ received from the manager 100 to thereby obtain Kₘ′. The station STA then compares Kₘ′ with Kₘ to determine whether Kₘ is equal to Kₘ for authenticity of the transmission source.

In this fashion, the station STA acquires the setting information and the key information (Kₙ,n) from the manager 100. At acquisition of the new key information Kₙ₋₁, the station STA conducts, by use of Kₙ₋₁, processing once on the basis of the hash function to obtain Kₙ. The station STA compares Kₙ′ with the key information Kₙ previously obtained from the manager 100 to determine whether Kₙ′ is equal to Kₙ for authenticity of the transmission source. If it is determined that the authenticity is confirmed, the station STA connects to the setting information manager 100 using a setting-dedicated SSID and then obtains setting information from the manager 100. As a result, while conducting an effective security measure to prevent an event in which the communication is hijacked by a false access point, the setting information can be automatically updated for each station.

Moreover, since the station STA determines, at acquisition of new key information, whether the new key information is equal to the previously obtained key information, authenticity of the transmission source can be established through highly reliable authentication using a hash function.

In the control operation shown in FIG. 15, the manager 100 transmits the setting information together with the new key information including Kₘ and m to the station STA in step E17. However, the manager 100 feeds the setting information together with key information including Kₙ₋₂ and n−2 to the station STA such that Kₙ₋₂ is used when the authentication is next carried out.

### Fifth Exemplary Embodiment

Description will now be given of the fifth exemplary embodiment.

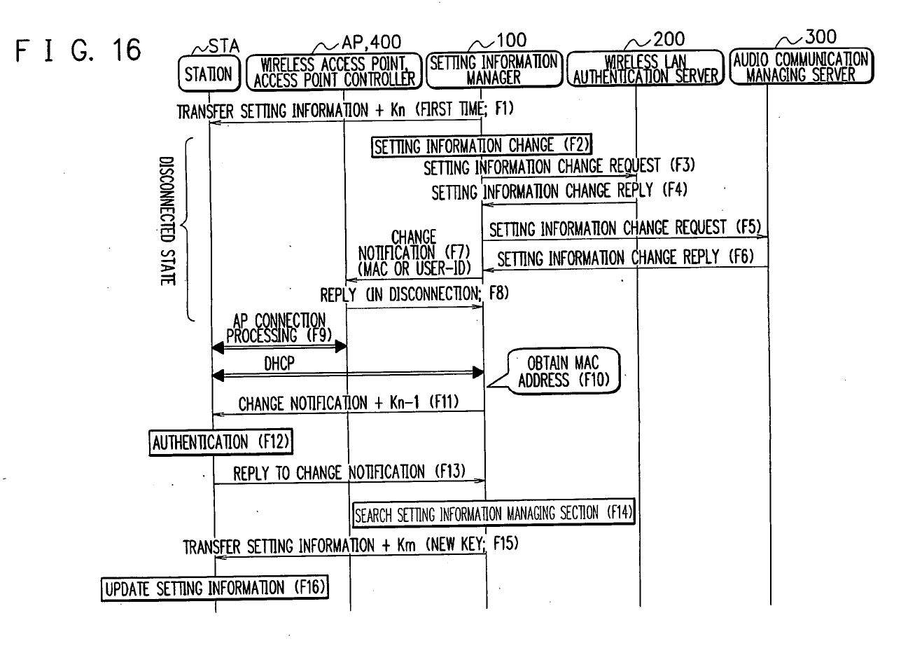

In the fourth exemplary embodiment, when the setting information which is unique to a station STA and is controlled by the setting information manager 100 is updated, the manager 100 delivers a change notification of the setting information to the access point controller 400. At reception of the change notification, if the controller 400 determines that it is impossible to connect to the station STA, the controller 400 enters a connection request wait state awaiting a connection request from the station STA. Thereafter, if the controller 400 determines that the station STA associated with the connection request wait state has issued a probe request to the access point AP, the controller 400 sends the change notification of setting information to the station STA. On receiving the notification, the station STA connects to the manager 100 via the access point AP using a setting-dedicated SSID. The station STA obtains the setting information from the manager 100 to update the setting information. In the fifth embodiment, when the station STA connects to the manager 100 via the access point AP by use of a setting-dedicated SSID, the change notification of the setting information is fed to the station STA. After receiving the notification, the station STA transmits to the manager 100 a response to the change notification. As a result, the station STA acquires the setting information from the manager 100 to update the setting information. In this way, the station STA periodically connects to the manager 100 using the setting-dedicated SSID to thereby attain the setting information updated by the manager 100. Referring now to FIG. 16, description will be given of operation of the fifth exemplary embodiment.

Processing of steps F1 to F8 shown in FIG. 16 is similar to steps E1 to E8 of the fourth exemplary embodiment shown in FIG. 15.

According to the control operation of the manager 100, when a disconnected state reply (in disconnection) is received from the controller 400, the manager 100 does not transmit the change notification, but waits for the station STA to attempt to connect to the manager 100 using a setting-dedicated SSID.

Next, the station STA in the disconnected state executes processing to connect to the access point AP by using a setting-dedicated SSID (step F9) to resultantly connect to the manager 100 on the sub-net to which the access point AP belongs (step F10).

After the station STA is connected as above, the manager 100 attains an MAC address of the station STA from the station STA and then sends, on the basis of the MAC address, the change notification together with key information including Kₙ₋₁ and n−1 to the station STA (step F11).

When the change notification is received from the manager 100, the station STA calculates Kₙ′ by once executing processing based on a hash function by use of Kₙ₋₁.

Subsequently, the station STA compares Kₙ′ with Kₙ attained in the previous information setting operation and thereby determines whether Kₙ′ is equal to Kₙ (step F12).

If it is determined that Kₙ′ is equal to Kₙ, the station STA determines that authenticity of the change notification received from the manager 100 is confirmed and sends a reply to the change notification to the manager 100 (step F13). In this operation, the station STA delivers unique identifying information to the manager 100.

After the reply is received, the manager 100 accesses the setting information manager section 102 to obtain the setting information of the station STA (step F14). The manager 100 then sends the setting information and new key information including Kₘ and m to the station STA (step F15).

Having received the information items, the station STA registers the setting information to the table 17 and manages Kₘ and m as encryption information (step F16).

Through the operation, the setting information is updated in the table 17 of the station STA. If the authentication processing is to be subsequently executed, the station STA carries out, using Kₘ and m, processing once based on the hash function by use of Kₘ₋₁ from the manager 100 to thereby obtain Kₘ′. The station STA compares Kₘ′ with Kₘ to determine whether Kₘ′ is equal to Kₘ to establish authenticity of the transmission source.

As above, the station STA acquires the setting information and the key information, i.e., Kₙ and n from the manager 100. The station STA connects to the manager 100 using the setting-dedicated SSID to attain new key information including Kₙ₋₁. On the basis of Kₙ₋₁, the station STA calculates Kₙ′ by executing processing once using a hash function and compares Kₙ′ with the previously obtained key information Kₙ for verification of authenticity of the transmission source. If it is determined that the authenticity is confirmed, the station STA obtains the setting information from the manager 100. Therefore, while a security measure is efficiently taken to prevent the communication from being hijacked by a false access point, it is possible to automatically update the setting information for each station STA.

Also, since the station STA determines, at acquisition of new key information, whether the new key information is equal to the previously acquired key information, authenticity of the transmission source can be confirmed through highly reliable authentication by use of a hash function.

According to the control processing of FIG. 16, the manager 100 feeds the setting information and the new key information (Kₘ and m) to the station STA in step F15. It is however possible for the manager 100 to deliver the setting information together with key information including Kₙ₋₂ and n−2 to the station STA such that Kₙ₋₂ is used in the next authentication processing.

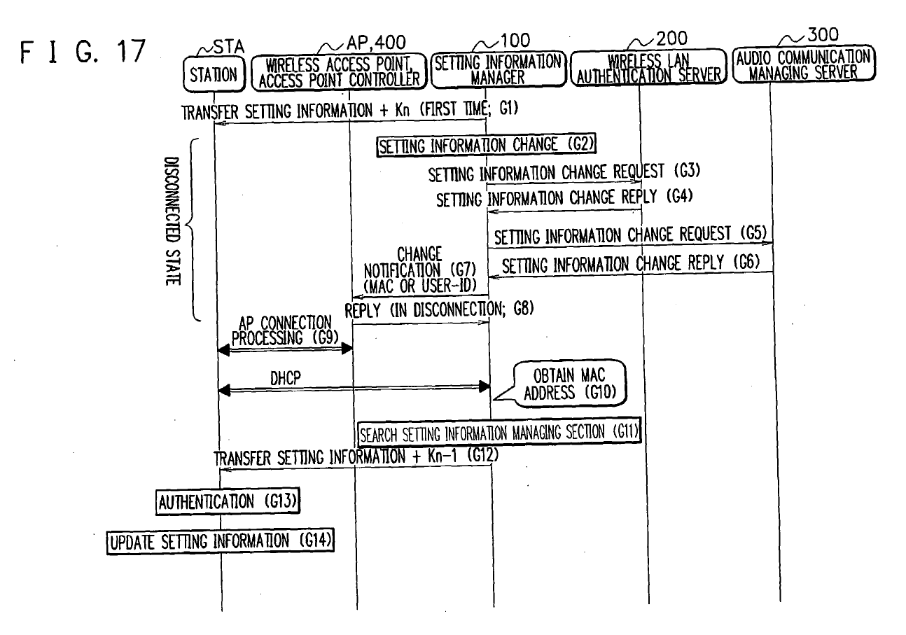

In the control operation shown in FIG. 16, the manager 100 transmits the change notification with the key information (Kₙ₋₁ and n−1) to the station STA using the MAC address obtained in step F11. However, for example, as can be seen from FIG. 17, based on the MAC address obtained from the station STA, the manager 100 may deliver the setting information together with Kₙ and n−1 to the station STA (step G12).

In the control operation of FIG. 17, the manager 100 searches the module 102 on the basis of the MAC address attained from the station STA to acquire the setting information of the station STA from the module 102 (step G11). The manager 100 then sends the setting information and new key information, i.e., Kₙ₋₁ and n−1 to the station STA (step G12).

When the setting information is received from the manager 100, the station STA conducts, by use of Kₙ₋₁, processing once on the basis of the hash function to obtain Kₙ′. The station STA compares Kₙ′ with the key information Kₙ obtained as a result of the previous information setting operation to determine whether Kₙ′ is equal to Kₙ (step G13).

If it is determined that Kₙ′ is equal to Kₙ, the station STA determines that the authenticity of the information from the manager 100 is confirmed. The station registers the setting information to the table 17 and manages Kₙ₋₁ and n−1 as encryption information (step G14).

### Sixth Exemplary Embodiment

The station may further include a setting information storage unit that stores therein the setting information. The setting information obtaining unit connects to the setting information managing device if the setting information is not stored in the setting information storage unit.

### Seventh Exemplary Embodiment

The setting information storage unit of the station may store therein the setting information with a relationship to managing information to individually manage the setting information, and the setting information obtaining unit may connect to the setting information managing device if the setting information related to particular managing information is not stored in the setting information storage unit.

### Eighth Exemplary Embodiment

The station may further include a setting information storage unit that stores therein the setting information. The setting information obtaining unit connects to the setting information managing device if wireless communication cannot be established using the setting information stored in the setting information storage unit.

### Ninth Exemplary Embodiment

The setting information storage unit may store therein the setting information with a relationship to managing information to individually manage the setting information and the setting information obtaining unit may connect to the setting information managing device if wireless communication cannot be established using the setting information related to particular managing information.

### Tenth Exemplary Embodiment

The station may further include a setting information storage unit that stores therein the setting information with a relationship to valid period information indicating a valid period of the setting information. The setting information obtaining module connects to the setting information managing device if the valid period indicated by the valid period information stored in the setting information storage unit expires.

### Eleventh Exemplary Embodiment

The setting information obtaining unit may connect to the setting information managing device if an acquisition request control operation to request acquisition of the setting information is carried out.

### Twelfth Exemplary Embodiment

The setting information obtaining unit may transmit identifying information unique to the station to the setting information managing device and acquire the setting information corresponding to the identifying information.

### Thirteenth Exemplary Embodiment

The setting information obtaining unit may transmit, after receiving a transmission request of the identifying information from the setting information managing device, the identifying information to the setting information managing device.

### Fourteenth Exemplary Embodiment

The connecting information may be a Service Set Identifier (SSID).

### Fifteenth Exemplary Embodiment

The setting information managing device may further include a setting information managing unit that manages the setting information for each identifying information unique to the station. The setting information transmission unit includes an identifying information acquiring unit that obtains the identifying information unique to the station from the station and a transmission unit that searches, based on the identifying information obtained by the setting information acquiring unit, the setting information managing unit to acquire setting information corresponding to the identifying information from the setting information managing unit and transmits the setting information to the station.

### Sixteenth Exemplary Embodiment

In the setting information managing device, the setting information transmission unit may include an identifying information acquiring unit that acquires from the station the identifying information unique to the station, a setting information creating unit that creates the setting information unique to the station based on the identifying information acquired by the identifying information acquiring unit, and a transmission unit that transmits the setting information created by the setting information creating unit to the station.

### Seventeenth Exemplary Embodiment

In the setting information managing device, the identifying information acquiring unit may transmit a transmission request of the identifying information to the station and acquires the identifying information from the station.

### Eighteenth Exemplary Embodiment

The setting information managing device may further include a setting information registration unit that registers the setting information created by the setting information creating unit to a wireless authentication device determining whether the wireless communication of the station is established.

### Nineteenth Exemplary Embodiment

In the wireless communication system, the station may include a setting information storage unit that stores the setting information. The setting information obtaining unit connects to the setting information managing device if the setting information is not stored in the setting information storage unit.

### Twentieth Exemplary Embodiment

In the wireless communication system, the setting information storage unit may store the setting information with a relationship to managing information to individually manage the setting information. The setting information obtaining unit connects to the setting information managing device if the setting information related to particular managing information is not stored in the setting information storage unit.

### Twenty-First Exemplary Embodiment

In the wireless communication system, the station further may include a setting information storage unit that stores the setting information. The setting information obtaining unit connects to the setting information managing device if wireless communication cannot be established using the setting information stored in the setting information storage unit.

### Twenty-Second Exemplary Embodiment

In the wireless communication system, the setting information storage unit may store the setting information with a relationship to managing information to individually manage the setting information. The setting information obtaining unit connects to the setting information managing device if wireless communication cannot be established using the setting information related to particular managing information and stored in the setting information storage unit.

### Twenty-Third Exemplary Embodiment

In the wireless communication system, the station may further include setting information storage unit that stores the setting information with a relationship to valid period information indicating a valid period of the setting information. The setting information obtaining unit connects to the setting information managing device if the valid period indicated by the valid period information stored in the setting information storage unit expires.

### Twenty-Fourth Exemplary Embodiment

In the wireless communication system, the setting information obtaining unit may connect to the setting information managing device if an acquisition request control operation to request acquisition of the setting information is carried out.

### Twenty-Fifth Exemplary Embodiment

In the wireless communication system, the setting information managing device may include a setting information managing unit that manages the setting information for each identifying information unique to the station, an identifying information acquiring unit that acquires from the station the identifying information unique to the station, and a transmission unit that searches, based on the identifying information obtained by the setting information acquiring unit, the setting information managing unit to acquire setting information corresponding to the identifying information from the setting information managing unit and transmits the setting information to the station.

### Twenty-Sixth Exemplary Embodiment

In the wireless communication system, the setting information managing device may include an identifying information acquiring unit that acquires from the station the identifying information unique to the station, a setting information creating unit that creates the setting information unique to the station based on the identifying information acquired by the identifying information acquiring unit, and a transmission unit that transmits the setting information created by the setting information creating unit to the station.

### Twenty-Seventh Exemplary Embodiment

In the wireless communication system, the identifying information acquiring unit may transmit a transmission request of the identifying information to the station and acquire the identifying information from the station.

### Twenty-Eighth Exemplary Embodiment

In the wireless communication system, the station may transmit, after receiving a transmission request of the identifying information from the setting information managing device, the identifying information to the setting information managing device.

### Twenty-Ninth Exemplary Embodiment

The wireless communication system may further include a wireless authentication device determining whether the wireless communication of the station is established. The setting information managing device includes a setting information registration unit that registers the setting information created by the setting information creating unit to the wireless authentication device.

The embodiments described above are only favorable embodiments in accordance with the present invention. The present invention is not restricted by the embodiments, but the embodiments can be changed and modified in various ways within the scope of the present invention.

For example, in the embodiments of the wireless communication system, the condition for the station STA to connect via the access point AC to the setting information manager 100 by use of the setting-dedicated SSID is not restricted by the exemplary embodiments. It is also possible to construct the system in which any possible conditions may be employed as triggers for the station STA to connect via access points to the manager 100 using the SSID.

In the embodiments, the control operations in the control devices such as an access point AP, a station STA, and the manager 100 may be accomplished using software such as computer programs, not the hardware configuration. The programs may be recorded in a computer-readable recording medium, for example, an optical recording medium, a magnetic recording medium, a magnetooptical recording medium, or a semiconductor recording medium such that the programs are installed in the controllers to thereby implement the control operations. Also, the programs may be attained via a predetermined network from an external device to be installed in the control devices for execution.

The station, the setting information managing device, the wireless communicating system, the setting information obtaining method, and the setting information obtaining program in accordance with the present invention are applicable to the automatic registration of particular information to a large number of stations, and in particular, suitable for registering the setting information required for wireless communication to the stations when the wireless communication is started.

An exemplary advantage according to the invention is that a station is capable of attaining setting information required for wireless communication by use of connection information for wireless connection to establish connection to a setting network. As a result, even if a large number of stations are installed, the setting information can be easily set to each station.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2006-188573, filed on Jul. 7, 2006, the disclosure of which is incorporated herein in its entirety by reference.

1. A station for obtaining the setting information from a setting information managing device managing setting information required for wireless communication, comprising a setting information obtaining unit which connects via an access point to the setting information managing device by use of setting information wireless connection to connect to a setting network and obtains the setting information from the setting information managing device.

2. The station in accordance with claim 1, further comprising a setting information storage unit which stores the setting information, wherein
the setting information obtaining unit connects to the setting information managing device if the setting information is not stored in the setting information storage unit.

3. The station in accordance with claim 2, wherein:
the setting information storage unit stores the setting information with a relationship to managing information to individually manage the setting information; and
the setting information obtaining unit connects to the setting information managing device if the setting information related to particular managing information is not stored in the setting information storage unit.

4. The station in accordance with claim 1, further comprising a setting information storage unit which stores the setting information, wherein
the setting information obtaining unit connects to the setting information managing device if wireless communication cannot be established using the setting information stored in the setting information storage unit.

5. The station in accordance with claim 4, wherein:
the setting information storage unit stores the setting information with a relationship to managing information to individually manage the setting information; and
the setting information obtaining unit connects to the setting information managing device if wireless communication cannot be established using the setting information related to particular managing information and stored in the setting information storage unit.

6. The station in accordance with claim 1, further comprising a setting information storage unit which stores the setting information with a relationship to valid period information indicating a valid period of the setting information, wherein
the setting information obtaining unit connects to the setting information managing device if the valid period indicated by the valid period information stored in the setting information storage unit expires.

7. The station in accordance with claim 1, wherein the setting information obtaining unit connects to the setting information managing device if an acquisition request control operation to request acquisition of the setting information is carried out.

8. The station in accordance with claim 1, wherein the setting information obtaining unit transmits identifying information unique to the station to the setting information managing device and acquires the setting information corresponding to the identifying information.

9. The station in accordance with claim 8, wherein the setting information obtaining unit transmits, after receiving a transmission request of the identifying information from the setting information managing device, the identifying information to the setting information managing device.

10. The station in accordance with claim 1, wherein the connecting information is a Service Set Identifier (SSID).

11. A setting information managing device for providing setting information required for wireless communication to a station, comprising a setting information transmission unit which transmits the setting information to the station connected via an access point existing on a setting network to the setting information managing device.

12. The setting information managing device in accordance with claim 11, further comprising a setting information managing unit which manages the setting information for each identifying information unique to the station, wherein the setting information transmission unit comprises:
an identifying information acquiring unit which acquires the identifying information unique to the station from the station; and
a transmission unit which searches, based on the identifying information obtained by the setting information acquiring unit, the setting information managing unit to obtain setting information corresponding to the identifying information from the setting information managing unit and transmits the setting information to the station.

13. The setting information managing device in accordance with claim 11, wherein the setting information transmission unit comprises:
an identifying information acquiring unit which acquires from the station the identifying information unique to the station;
a setting information creating unit the setting which creates information unique to the station based on the identifying information acquired by the identifying information acquiring unit; and
a transmission unit which transmits the setting information created by the setting information creating unit to the station.

14. The setting information managing device in accordance with claim 12, wherein the identifying information acquiring unit transmits a transmission request of the identifying information to the station and acquires the identifying information from the station.

15. The setting information managing device in accordance with claim 13 further comprising a setting information registration unit which registers the setting information created by the setting information creating unit to a wireless authentication device determining whether the wireless communication of the station is established.

16. A wireless communication system comprising:
a setting information managing device for managing setting information required for wireless communication;
an access point; and
a base station for belonging to the access point for conducting wireless communication,
the station comprising a setting information obtaining unit which connects via an access point to the setting information managing device by use of setting information for wireless connection to connect to a setting network and obtains the setting information from the setting information managing device.

17. The wireless communication system in accordance with claim 16, wherein the station comprises a setting information storage unit which stores the setting information, wherein
the setting information obtaining unit connects to the setting information managing device if the setting information is not stored in the setting information storage unit.

18. The wireless communication system in accordance with claim 17, wherein:
the setting information storage unit stores the setting information with a relationship to managing information to individually manage the setting information; and
the setting information obtaining unit connects to the setting information managing device if the setting information related to particular managing information is not stored in the setting information storage unit.

19. The wireless communication system in accordance with claim 16, wherein:
the station further comprises a setting information storage unit which stores the setting information; and
the setting information obtaining unit connects to the setting information managing device if wireless communication cannot be established using the setting information stored in the setting information storage unit.

20. The wireless communication system in accordance with claim 19, wherein:
the setting information storage unit stores the setting information with a relationship to managing information to individually manage the setting information; and
the setting information obtaining unit connects to the setting information managing device if wireless communication cannot be established using the setting information related to particular managing information and stored in the setting information storage unit.

21. The wireless communication system in accordance with claim 16, wherein:
the station further comprises a setting information storage unit which stores the setting information with a relationship to valid period information indicating a valid period of the setting information; and
the setting information obtaining unit connects to the setting information managing device if the valid period indicated by the valid period information stored in the setting information storage unit expires.

22. The wireless communication system in accordance with claim 16, wherein the setting information obtaining unit connects to the setting information managing device if an acquisition request control operation to request acquisition of the setting information is carried out.

23. The wireless communication system in accordance with claim 16, wherein the setting information managing device comprises:
a setting information managing unit which manages the setting information for each identifying information unique to the station;
an identifying information acquiring unit which acquires from the station the identifying information unique to the station; and
a transmission unit which searches, based on the identifying information obtained by the setting information acquiring unit, the setting information managing unit to acquire setting information corresponding to the identifying information from the setting information managing unit, and transmits the setting information to the station.

24. The wireless communication system in accordance with claim 16, wherein the setting information managing device comprises:
an identifying information acquiring unit which acquires from the station the identifying information unique to the station;
a setting information creating unit which creates the setting information unique to the station based on the identifying information acquired by the identifying information acquiring unit; and
a transmission unit which transmits the setting information created by the setting information creating unit to the station.

25. The wireless communication system in accordance with claim 23, wherein the identifying information acquiring unit transmits a transmission request of the identifying information to the station and acquires the identifying information from the station.

26. The wireless communication system in accordance with claim 25, wherein the station transmits, after receiving a transmission request of the identifying information from the setting information managing device, the identifying information to the setting information managing device.

27. The wireless communication system in accordance with claim 24, further comprising a wireless authentication device determining whether the wireless communication of the station is established, wherein
the setting information managing device comprises a setting information registration unit which registers the setting information created by the setting information creating unit to the wireless authentication device.

28. A setting information obtaining method for use with a station for obtaining the setting information from a setting information managing device managing setting information required for wireless communication, the method comprising a setting information obtaining step of connecting, by the station, via an access point to the setting information managing device by use of setting information for wireless connection to connect to a setting network, and obtaining the setting information from the setting information managing device.

29. A setting information obtaining method in which a setting information managing device provides setting information required for wireless communication to a station and the station obtains the setting information, the method comprising a setting information transmission step of transmitting, by the setting information managing device, the setting information to the station connected via an access point existing on a setting network to the setting information managing device.

30. A setting information obtaining method for use with a wireless communication system comprising a setting information managing device for managing setting information required for wireless communication, an access point, and a base station for belonging to the access point for conducting wireless communication, the method comprising a setting information obtaining step of connecting, by the station, via an access point to the setting information managing device by use of setting information for wireless connection to connect to a setting network, and obtaining the setting information from the setting information managing device.

31. A computer-readable medium having computer-executable instructions for performing a method for a station to obtain setting information, the method comprising the steps of: connecting via an access point to a setting information managing device by use of setting information for wireless connection to connect to a setting network; and obtaining the setting information from the setting information managing device.

32. A computer-readable medium having computer-executable instructions for performing a method for a device to provide a station with setting information, the method comprising the step of: transmitting the setting information to the station connected via an access point existing on a setting network to the device.

33. A station for obtaining the setting information from a setting information managing device managing setting information required for wireless communication, comprising a setting information obtaining means for connecting via an access point to the setting information managing device by use of setting information for wireless connection to connect to a setting network and for obtaining the setting information from the setting information managing device.

34. A setting information managing device for providing setting information required for wireless communication to a station, comprising setting information transmission means for transmitting the setting information to the station connected via an access point existing on a setting network to the setting information managing device.

35. A wireless communication system comprising:
a setting information managing device for managing setting information required for wireless communication;
an access point; and
a base station for belonging to the access point for conducting wireless communication,
the station comprising a setting information obtaining means for connecting via an access point to the setting information managing device by use of setting information for wireless connection to connect to a setting network and for obtaining the setting information from the setting information managing device.
